(19) United States
(12) Patent Application Publication
(10) Pub. No.: US 2005/0273540 A1
(43) Pub. Date: Dec. 8, 2005

(54) Interrupt handling system

(75) Inventor: Jeremy P. Whaley, Bristol (GB)

Correspondence Address: Docket Clerk, P.O. Box 802432, Dallas, TX, 75380, US

(73) Assignee: STMICROELECTRONICS LIMITED, Bristol (GB)

(21) Appl. No.: 11/127,049

(22) Filed: May 11, 2005

(30) Foreign Application Priority Data
May 11, 2004 (EP) 04252720.0

(51) Int. Cl. G06F 13/24

(52) U.S. Cl. 710/260

(57) ABSTRACT

The invention provides an interrupt handling system to process a generated interrupt. At least one input is arranged to provide a predetermined active level, with a detection circuit associated with the input which is selectively configurable to detect either the active level or an inactive level. An interrupt request message causes the detection circuit to be configured to detect the active level, so that an enable logic is caused to generate an interrupt. The invention provides an integrated circuit and a method of generating interrupts using the above system, and a consumer electronic device in the form of a set top box or DVD Read and/or Write device.

### TECHNICAL FIELD OF THE INVENTION

The present invention relates to an interrupt handling system, particularly for processor generated interrupts.

### BACKGROUND OF THE INVENTION

Many integrated circuits now have integrated onto a single chip a complete system using multiple processors and other dedicated devices. A set top box is one example of a system on a chip. Where multiple processors form part of the system, they need to be able to communicate with one another and this is done by way of interprocessor interrupts. Currently, these are managed by a mailbox which receives a message from one processor that it wishes to interrupt another on-chip processor, and generates the interrupt accordingly. The mailbox includes enable/clear logic and optionally a status register for dealing with these interprocessor interrupts. The mailbox has a dedicated interface to a system bus to which the processors are connected and only deals with the interprocessor interrupts.

Interprocessor interrupts may include, in addition to the interrupt itself, extra information, for example the location of data associated with the interrupt. The mailbox includes memory locations, for example in the form of registers, which allow this information to be held and accessed by the processor being interrupted.

Additionally, an on-chip system generally includes an interrupt level controller which handles other interrupts of the system, for example external interrupts which are received from the chip pads and internal interrupts which are received from the other on-chip active devices. An interrupt level controller has an array of inputs associated with the different sources of interrupts and includes enable/clear logic, routing logic and detection logic for detecting interrupts. An interrupt level controller may include status registers which hold the status of interrupts, but it does not include any way of handling additional information of a type which might be required with interprocessor interrupts. However, the interrupt level controller does allow the mapping of different interrupts to different processors, switching them on and off, clearing them and thus provides a great deal of flexibility.

Interrupt level controllers are known which have detection circuits associated with the respective interrupt inputs, the detection circuit being configurable to detect different types of interrupt, for example high level, low level, rising edge, falling edge, edge or no edge (i.e. never detects).

### SUMMARY OF THE INVENTION

To address the above-discussed deficiencies of the prior art, it is a primary object of the present invention to remove the need for a mailbox yet still allow flexible interprocessor interrupts to be implemented.

According to one aspect of the invention there is provided an interrupt handling system for processor generated interrupts comprising: at least one input arranged to provide a predetermined active level; a detection circuit associated with the at least one input and selectively configurable to detect either the active level or an inactive level; control circuitry responsive to an interrupt request message from a processor to configure the detection circuit to detect the active level; and enable logic responsive to detection of the active level by the detection circuit to generate an interrupt.

There can be a set of such inputs, each associated with its own respective configurable detection circuit and a respective one of a set of on-chip processors.

The predetermined active level can be high or low and can be provided by tying an input pin to a high or low voltage accordingly.

The invention also provides an integrated circuit which includes such an interrupt handling system, a set of processors interconnected by a system bus and a shared memory resource connected to the system bus.

The invention also provides in another aspect a method of generating interrupts comprising: generating from a first processor an interrupt request message; configuring detection circuitry associated with at least one interrupt input which is arranged to provide a predetermined active level so that said detection circuit is configured to detect the active level; and generating an interrupt to the second processor responsive to the detection circuit detecting the active level.

The invention further provides a consumer electronic device in the form of a Set Top Box or DVD Read and/or Write device utilizing the above defined system or method.

The following described embodiment allows the mailbox functionality to be implemented with minor modifications to existing interrupt level controllers.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” may be used to mean any device, system or part thereof that controls at least one operation, such a device may be implemented in hardware, firmware or software, or some combination of at least two of the same. It should be noted that the functionality associated with any particular apparatus or controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a better understanding of the present invention and to show how the same may be carried into effect, reference will now be made by way of example to the accompanying drawing in which like reference numerals represent like parts, and in which:

FIG. 1 is a schematic diagram of a known interrupt handling system;

FIG. 2 is a schematic diagram of an interrupt handling system in accordance with one embodiment of the invention; and

FIG. 3 is a block diagram of a modified interrupt level controller.

### DETAILED DESCRIPTION OF THE INVENTION

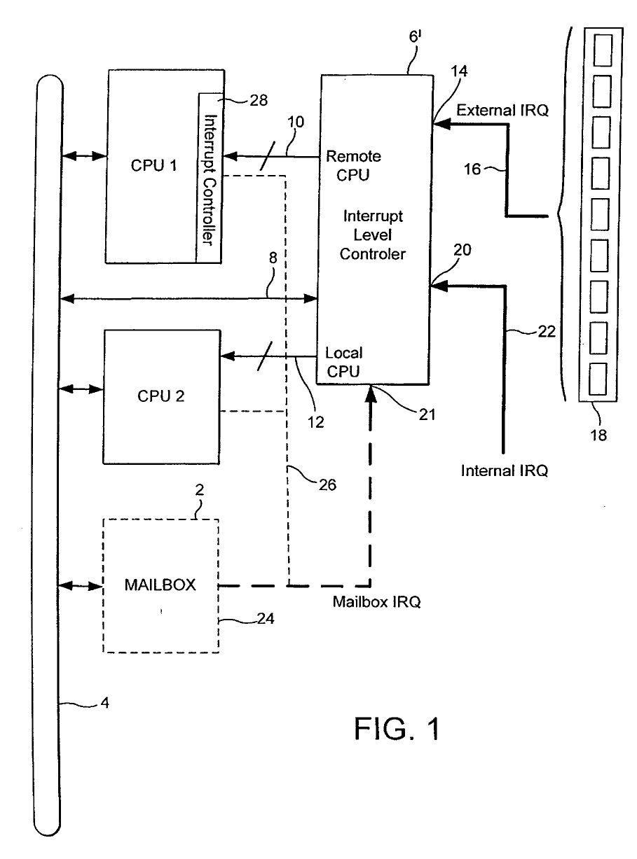

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged interrupt handling system, particularly any suitably arranged processor generated interrupts.

FIG. 1 is a schematic block diagram of the relevant components of an integrated circuit with multiple processors to show the schema for handling interrupts. On-chip circuitry comprises a first processor CPU1, a second processor CPU2 and a mailbox 2 which are connected to a system bus 4. An interrupt level controller 6 is also connected to the system bus via communication path 8 which allows the interrupt level controller 6 to be configured as will be explained later. The interrupt level controller 6 is connected to the first processor CPU1 via a first interrupt path 10 for passing interrupts to that processor. The first processor CPU1 is sometimes referred to herein as the remote processor. The interrupt level controller 6 also has a second interrupt path 12 connected to the second processor CPU2, which is sometimes referred to herein as the local processor. The interrupt level controller 6 has a first set of inputs 14 for receiving external interrupt requests 16 which come, for example, from pads 18 of the integrated circuit, and a second set of inputs 20 for receiving internal interrupt requests 22 which come from other devices on the same chip. Optionally, the interrupt level controller has an input for receiving mailbox interrupt requests. The mailbox 2 has an output 24 which outputs interrupt requests either to the interrupt level controller via input 21 or to each of the first and second processors directly as indicated by the dotted path 26.

Although not shown in FIG. 1 each input in the set of external request inputs 14 is associated with detection logic which is configurable to detect one of the different kinds of interrupts, that is high level, low level, rising edge, falling edge, any edge or no edge. The detection circuit at each input is independently configurable via the communication path 8 under the control of one of the processors CPU1, CPU2. The detection circuits are configured, for example, at the start of each application so that an interrupt arriving at any particular input is detected in the proper manner. The interrupt level controller 6 also includes enable/clear logic and routing logic which will be described in more detail later in the context of an embodiment of the invention.

Each processor is equipped with an interrupt controller, which is shown by reference numeral 28 for the first processor CPU1. A similar interrupt controller is present in the second processor CPU2 although it is not shown in FIG. 1. These interrupt controllers handle interrupts in a known manner.

When one of the processors CPU1, CPU2 wishes to dispatch an interrupt to the other processor, it addresses a message to the mailbox 2 and the message is transmitted via the system bus 4. The message can include additional information such as data or a memory address associated with the interrupt. The interrupt level controller reads an interrupt request on input 21 from the mailbox 2 and if enabled and routed, generates an interrupt along path 10, 12 to the appropriate processor CPU1, CPU2. The mailbox 2 contains a status register which can be read by the processor being interrupted to determine the status of the interrupt, i.e. whether it is still pending or whether it is cleared. Thus, if, for example, the second processor CPU2 sends a message to the mailbox 2 to cause an interrupt to be generated to the first processor CPU1, the interrupt controller 28 reads the interrupt request and routes the interrupt over path 10 to the first processor CPU1. The first processor CPU1 then reads the mailbox 2 or the interrupt level controller 6 to clear the interrupt request when it has been dealt with.

The mailbox 2 optionally includes memory for holding the additional information which can be sent with the interrupt request message. This additional information can be accessed by the interrupted processor over the system bus 4.

As has been explained earlier, it would be desirable to have an interrupt handling system which avoids the need for a separate mailbox.

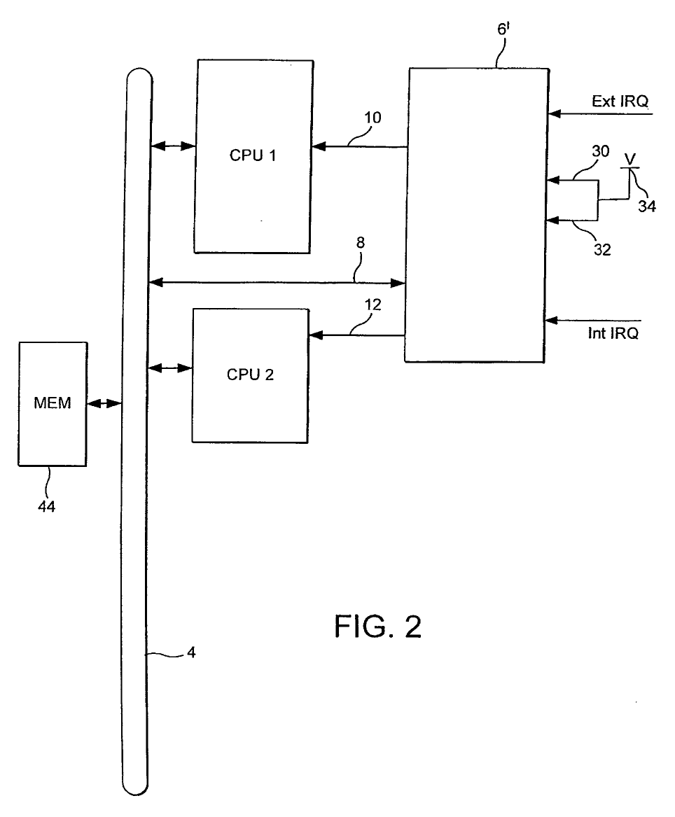

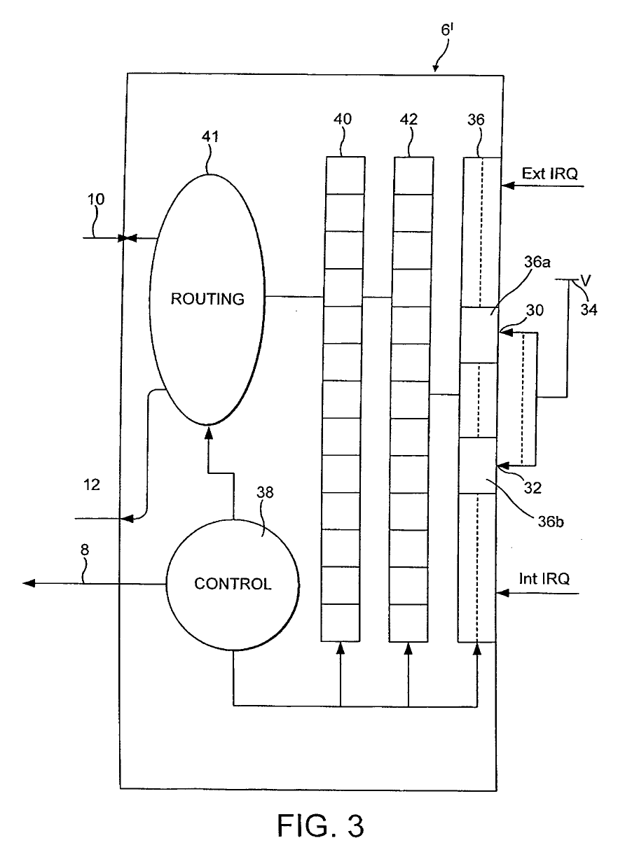

FIG. 2 illustrates a schematic block diagram in which the processors can generate interrupts for each other without the use of a mailbox. In FIG. 2, like numerals denote like parts as in FIG. 1. The interrupt level controller is denoted 6′ to distinguish it from the interrupt level controller 6 of FIG. 1, though the functionality is the same. The interrupt level controller 6′ includes a set of additional inputs, two of which 30, 32 are shown in FIG. 2. The difference lies in the way these inputs are handled. While only two additional inputs are shown, there is at least one separate additional input for each processor in the system. There might, for example, be more than one additional input associated with each processor to indicate interrupts of different priority levels. The additional inputs 30, 32 are tied to a common active level. In this example input 30 is associated with CPU1 and input 32 with CPU2. In the present description, the active level is considered to be high, but it will be appreciated that the logic could be reversed. As shown in more detail in FIG. 3, the interrupt level controller 6′ includes detect logic 36 which has detect circuits associated with the inputs and including circuits 36a, 36b for each of the additional inputs 30, 32. The interrupt level controller 6′ includes control logic 38 which configures the detect circuits 36 under the control of one of the processors CPU1, CPU2 via the communication path 8. The interrupt level controller 6′ also includes enable/clear registers 40, routing logic 41 and a set of status registers 42, one associated with each input. The system additionally includes shared memory 44 connected to the system bus 4.

The system operates as follows to deal with interprocessor interrupts. At set-up, for example at the commencement of a new application to be executed by the system, the detection circuits 36 are each configured to detect the kind of interrupt expected at their associated input, as already described with reference to FIG. 1. In the case of the embodiment of FIG. 2, the detection circuits 36a, 36b associated with each of the additional inputs 30, 32 are set to detect a zero or low level. That is, in normal operation no interrupt will be detected by the detection circuits 36a, 36b associated with the additional inputs. When one of the processors CPU1, CPU2 wishes to generate an interrupt to the other processor, it first generates a message which is transmitted along communication path 8 to the control logic 38 of the interrupt level controller 6′ which reconfigures the detection circuit associated with the input for the processor which is to be interrupted. Say, for example, in the case of the first processor CPU1 wishing to generate an interrupt to the second processor CPU2, a message is sent by the path 8 to the control logic 38 to reconfigure the detection circuit 36b so that it now detects a one (or high), rather than a zero. As that input is permanently tied to active high, it will immediately respond as though an interrupt has been received at that input. That is, the status register in the block 42 associated with that input is set to a status of interrupt pending, and the associated enable/clear register 40 is set to generate an interrupt along path 12 via the routing logic 41. The routing logic 41 maps interrupts received at the set of inputs 14, 20, 30, 32 to the appropriate processor based on the source of the interrupts. The routing logic is configured when the system is set up and the interrupts are first determined. The routing logic is also sometimes referred to as mapping logic. In this case, the routing logic 42 determines that the interrupt was detected at the additional input 32 which is an interrupt source intended for the second processor CPU2. Therefore, the interrupt is generated along path 12. If the interrupt was associated with additional information, the first processor accesses the shared memory 44 and stores that additional information in a predetermined location. When the interrupt is handled by the second processor CPU2, that processor accesses the shared memory 44 at the predetermined location to extract the additional information. Once the interrupt has been handled, a message is sent via path 8 to the interrupt level controller 6′. The message is handled by the control logic 38 to cause the enable/clear register 40 to clear the pending status of the interrupt in the status register and to reconfigure the detect circuit associated with the additional input 32 so that it once again is set to detect a zero (or low).

The shared memory 44 is a resource which is already available on the chip, and which in this embodiment has a set of predetermined locations associated with each of the processors CPU1, CPU2 for holding information about the interrupt, for example its reason and priority.

External and internal interrupt requests received at the inputs 14, 20 are handled in the normal way. It is not expected that interrupts arriving at these pins will have additional information to be shared.

The removal of the mailbox from the interrupt system saves chip area and reduces chip complexity for message paths. It has been appreciated that it is possible to use functionality which already exists in the interrupt level controller on the chip to provide the interprocessor interrupts. It is intended that the present invention encompass such changes and modifications as fall within the scope of the appended claims.

1. An interrupt handling system for processor generated interrupts comprising:
at least one input arranged to provide a predetermined active level;
a detection circuit associated with the at least one input and selectively configurable to detect either the active level or an inactive level;
control circuitry responsive to an interrupt request message from a processor to configure the detection circuit to detect the active level; and
enable logic responsive to detection of the active level by the detection circuit to generate an interrupt.

2. An interrupt handling system according to claim 1, which comprises a set of inputs arranged to provide said predetermined active level, each input being associated with a respective processor of the system.

3. An interrupt handling system according to claim 2, wherein the interrupt request message identifies a processor to be interrupted, wherein the control circuitry is responsive to the interrupt request message to configure the detection circuit associated with the input for the processor to be interrupted to detect the active level.

4. An interrupt handling system according to claim 1, which comprises at least one status register associated with said at least one input for holding the status of the interrupt.

5. An interrupt handling system according to claim 3, which comprises routing logic for routing the interrupt to the identified processor.

6. An integrated circuit which comprises:
a plurality of processors interconnected via a system bus;
a memory connected to the system bus; and
an interrupt handling system according to any preceding claim.

7. An integrated circuit according to claim 6, wherein the interrupt request message identifies a location in said memory where additional information concerning the interrupt is stored by the interrupt generating processor for access by the interrupted processor.

8. A method of generating interrupts comprising:
generating from a first processor an interrupt request message;
configuring detection circuitry associated with at least one interrupt input which is arranged to provide a predetermined active level so that said detection circuit is configured to detect the active level;
generating an interrupt to a second processor responsive to the detection circuit detecting the active level.

9. A consumer electronic device comprising an interrupt handling system for processor generated interrupts comprising:
at least one input arranged to provide a predetermined active level;
a detection circuit associated with the at least one input and selectively configurable to detect either the active level or an inactive level;
control circuitry responsive to an interrupt request message from a processor to configure the detection circuit to detect the active level; and
enable logic responsive to detection of the active level by the detection circuit to generate an interrupt.

10. A consumer electronic device according to claim 9 which is a Set Top Box.

11. A consumer electronic device according to claim 9 which is at least one of a DVD Read device and a DVD Write device.
